(19) United States
(12) Patent Application Publication
(10) Pub. No.: US 2012/0006671 A1
(43) Pub. Date: Jan. 12, 2012

(54) CONTROL OF SCALE FORMATION IN PRODUCED WATER EVAPORATORS

(75) Inventor: James Charles Nowak, Kent, WA (US)

(73) Assignee: GENERAL ELECTRIC COMPANY, Schenectady, NY (US)

(21) Appl. No.: 12/831,443

(22) Filed: Jul. 7, 2010

(51) Int. Cl. C02F 5/10; B01D 3/34

(52) U.S. Cl. 203/7; 210/701

(57) ABSTRACT

Methods for inhibiting scale formation in evaporators of the type used to produce aqueous distillate from produced waters such as those waters that are commonly formed in steam assisted gravity drainage (SAGD) oil recovery methods are provided. In accordance with the invention, a chelant selected from EDTA, DTPA, NTA, and HEEDTA is added to the recirculating evaporator system brine or to the feedwater to such systems.

### FIELD OF THE INVENTION

The invention pertains to methods for inhibiting scale formation in evaporators of the type used to produce aqueous distillate from produced waters such as those waters that are commonly formed in steam assisted gravity drainage (SAGD) oil recovery methods.

### BACKGROUND OF THE INVENTION

Over the past few years, water treatment and steam generation methods for heavy oil recovery processes have rapidly evolved. Traditionally, especially for cyclic steam operations, once-through steam generators (OTSG), driven by natural gas, have been used to produce about 80% quality steam (80% vapor, 20% liquid) for injection into the well to fluidize the heavy oil. However, the relatively new heavy oil recovery method referred to as steam assisted gravity drainage (SAGD) requires 100% quality steam for invention. Accordingly, in order to allow the continued use of OTSG for SAGD applications, a series of vapor-liquid separators is required to produce the required steam quality. For both SAGD and non-SAGD applications, pretreatment of the OTSG feedwater has consisted of silica reduction in a hot or warm lime softener, filtration, and hardness removal by weak acid cation (WAC) ion exchange. In most cases, the OTSG blowdown is disposed of by deep well injection.

As the use of SAGD process becomes increasingly common for heavy oil recovery in Alberta and worldwide, the traditional methods of produced water treatment and steam generation have been re-evaluated to determine whether other alternative methods may provide more technically and economically viable solutions. One such alternate method of produced water treatment, namely the use of vertical tube mechanical vapor compression (MVC) evaporation, has rapidly become the “baseline” approach against which other technologies are evaluated. This technology has been evaluated by several Alberta oil producers to provide numerous technical and economic advantages over the traditional approach. In addition, the evaporative produced water treatment technology allows the use of standard or “packaged” drum boilers in lieu of OTSG for steam generation, providing further technical and economic benefits.

Typically, in SAGD operations, the oil/water mixture coming out of the production well is sent to a primary oil/water separator where the majority of the oil is separated from the produced water. Typical separators include free water knock outs which provide for gravity separation. The thus separated produced water may then be sent to a cone bottom tank wherein heavy solids such as sand and the like settle out. Induced gas flotation units may also be used to effect further separation. The produced water may then be further de-oiled by a polymer de-oiling step.

In those situations in which an evaporator is employed upstream from the boiler in SAGD recovery methods, a base such as caustic may be added to the produced water to increase pH and silica solubility in the evaporator. The produced water is commonly fed through a heat exchanger in heat exchange relationship with hot distillate exiting from the evaporator. The produced water is then fed to a deaerator to remove dissolved gasses such as O₂ and CO₂ that may be present. Typically, the produced water is then admitted to the sump of a brine recirculation system wherein a pump transports the mixture of produced water and brine to the top of a stack of falling film evaporator tubes such as shown for example in FIGS. 4, 5, and 12 of U.S. Pat. No. 7,428,926 (Heins—of common assignment herewith). The entire content of this patent is incorporated by reference herein.

If the produced water in the evaporator is not treated, harmful scale can form on evaporator components leading to increased downtime for cleaning and impairment of heat exchange functions necessary for optimal operation of the evaporator.

### SUMMARY OF THE INVENTION

In one aspect of the invention, a method is provided for inhibiting scale formation in an evaporator of the type having a sump in communication with a brine recirculation system. The evaporator is adapted to form distillate for feed to a boiler in a steam assisted gravity discharge (SAGD) oil recovery method. Feedwater is provided to the evaporator from SAGD produced water. An effective amount of a chelant selected from the group consisting of ethylenediaminetetraacetic acid (EDTA), nitrilotriacetic acid (NTA), and hydroxyethylethylenediaminetriacetic acid (HEEDTA) and water soluble salts thereof are added to the evaporator feedwater or to the brine recirculation system such as by addition to the sump. The chelants may be present in the sodium salt form and may be fed to the system in an amount of about 0.3 to 1.3 times the stoichiometric amount of chelatable species in the brine recirculation system.

In another exemplary embodiment, the evaporator is a falling film, vapor compression evaporator, and in another exemplary embodiment, the chelant fed to the feedwater or brine recirculation system is EDTA.

In another aspect of the invention, methods for inhibiting scale formation in evaporators are disclosed wherein the evaporator is used to evaporate water vapor in the form of distillate from a liquid medium wherein the liquid medium comprises oil, water, scale causing ions, and silica. In this aspect of the invention, the method comprises adding to the liquid medium an effective amount of a chelant selected from the group consisting of EDTA, DTPA, NTA, and HEEDTA. Further, in many system waters, the silica present may be in an amount of about 7,500-10,000 ppm and dissolved salt concentrations of such liquid media may range from about 5-12%. In another embodiment, the pH of the liquid media may be from about 10-12.5.

In other exemplary embodiments, the treatment is chosen to inhibit scale formation particularly of calcium silicate and calcium carbonate. In another embodiment, methods of evaporating aqueous distillate from a liquid medium in a system prone to calcium silicate deposition is provided. Such calcium silicate would normally form on structural parts in contact with the system water. In these systems, the invention includes addition of a chelant selected from EDTA, DTPA, NTA, and HEEDTA to the system waters in order to inhibit the calcium silicate deposition on structural parts in contact with the system water. Typical system water chemistries include those having pH of about 10-12.5 and a silica content of about 7,500-10,000 ppm with a calcium ion content of greater than about 60 ppm.

### BRIEF DESCRIPTION OF THE DRAWINGS

The invention will be further described in conjunction with the appended drawings wherein:

FIG. 1 is a schematic process diagram of a process utilizing an evaporator to provide feedwater to a boiler in a typical SAGD process; and

FIG. 2 is a simplified schematic process diagram of a vertical tube falling film evaporator system used to provide feedwater to a boiler in a typical SAGD process.

### DETAILED DESCRIPTION OF EXEMPLARY EMBODIMENTS

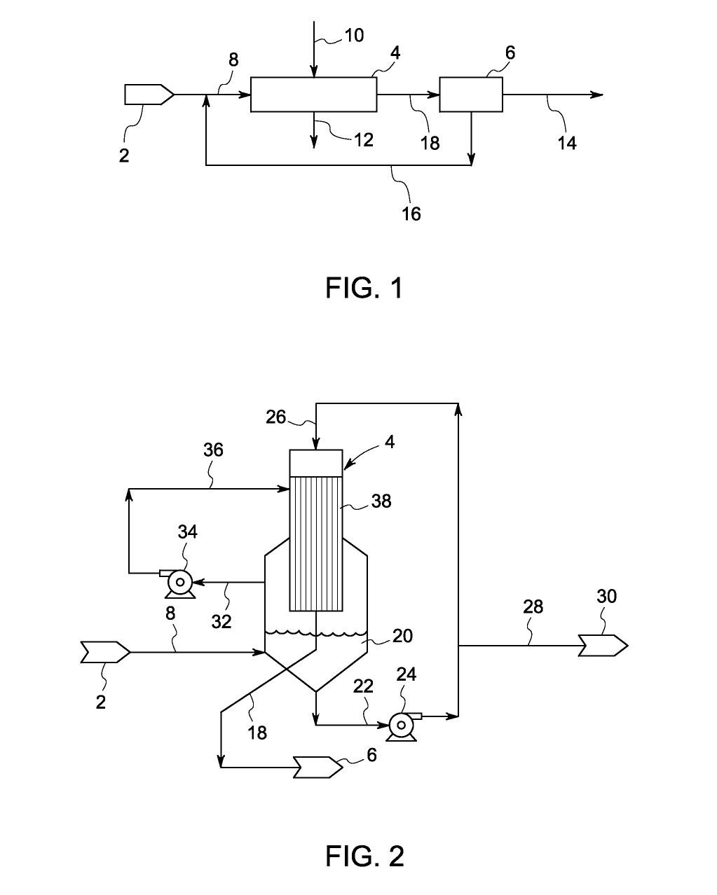

Turning first to FIG. 1 of the drawings, de-oiled produced water is fed from a feed tank or the like 2 through feed conduit 8 to evaporator 4. This produced water is typically that produced as the result of SAGD recovery methods wherein steam is injected into the oil well to allow the oil/water mixture to be brought to the surface. The oil is recovered as product with the produced water being de-oiled as described above. The evaporator 4 may be any type of evaporator such as a horizontal tube evaporator, forced circulation evaporator, or rising film evaporator, but preferably, the evaporator is a vertical tube falling film evaporator with condensed vapor recycling capabilities as shown in FIG. 2.

Distillate from the evaporator exits evaporator 4 through conduit 18 and is then utilized, with or without additional treatment, as feedwater for an OTSG or drum boiler. The boiler is utilized to form steam 14 that is, in turn, then utilized in the SAGD process to recover oil from the oil recovery formation such as the tar sands formations existing in Northwest Canada. Blowdown from the boiler may be recycled as shown by the use of conduit 16 for feed to the produced water upstream from the evaporator 4. Blowdown from the evaporator 12 may also be forwarded to a disposal site or to a zero liquid discharge crystallizer system or systems that may be employed.

In accordance with one aspect of the invention, chelant such as ethylenediaminetetraacetic acid (EDTA), diethylenetriaminepentaacetic acid (DTPA), nitrilotriacetic acid (NTA) or hydroxyethylethylenediaminetriacetic acid (HEEDTA) is fed to the evaporator as shown, for instance, at 10 in order to chelate the hardness and other scale forming species in the evaporator. Specific dosages of the chelant are determined by the conditions existing in the particular evaporator system. Exemplary dosages are 0.3 to 3 parts per part of chelant of chelatable species.

A schematic of a vertical tube falling film evaporator with recycled vapor system is shown in FIG. 2. Here, deoiled produced water is fed from feedtank 2 through conduit 8 into sump 20 of a recirculating brine system shown by conduits 22 and 26 with intermediate pump 24. Distillate exits the evaporator at 18 and is fed (with or without additional treatment) to an OTSG or drum boiler as designated at 6. Blowdown from the brine recycle system is drawn through conduit 28 and may be passed to a zero discharge crystallizer or deep well 30. Vapor in the system is recycled via use of inlet conduit 32 in combination with compressor 34 and recycle return line 36 which feeds the recycled vapor to the top of the vertical tubes 38 disposed in the evaporator 4.

In systems such as those shown in FIG. 2, the produced water may enter a feed tank wherein the pH is adjusted to a range of about 10 to 12.5 via caustic addition to increase the solubility of silica in the water. The feedwater may be pumped through a feed exchanger (not shown) that raises its temperature to the boiling point. In this heat exchanger, hot distillate transfers its sensible heat to the feedwater. Typically, this produced water is then forwarded through a deaerator, which removes noncondensible gases such as oxygen. Hot deaerated feed enters the evaporator sump where it combines with the recirculating brine slurry. The slurry is pumped to the top of a bundle of heat transfer tubes 38 where it flows through the individual tube distributors. As the brine falls down the tubes 38, a small portion evaporates and the rest falls in the sump to be recirculated.

The vapor travels down the tubes 38 with the brine and is drawn up through mist eliminators through conduit 32 to condenser 34. Distillate exiting at 18 may be pumped back through the heat exchanger where it will give up its sensible heat to the incoming produced water entering the evaporator through conduit 8. A small amount of the brine slurry is continuously released through blowdown line 28.

Typical SAGD produced water, used as feedwater to the evaporator, includes soluble and insoluble organic and inorganic components. The inorganic components can be salts such as sodium chloride, sodium sulfate, calcium chloride, calcium carbonate, calcium phosphate, barium chloride, barium sulfite, and other like compounds. Metals, such as copper, nickel, lead, zinc, arsenic, iron, cobalt, cadmium, strontium, magnesium, boron, chromium, and the like may also be included. Organic compounds which are typically dissolved and emulsified are hydrocarbons such as benzene, toluene, phenol, and the like. The produced water typically contains about 5-25 ppm residual oil, and most often this is within the range of about 10-20 ppm. Typically, encountered chemistries of the SAGD produced water show the presence of about 2 ppm Ca⁺⁺ and 220 ppm silica as SiO₂.

One exemplary SAGD produced water has the following chemistry:

| | PRODUCED |
|---|---|
| | WATER |
| ANALYTE | mg/L |
| pH, standard units @ 20° C. | 7.5 |
| Conductivity, μmhos/cm | 1,620 |
| Total Suspended Solids | 20² |
| Total Dissolved Solids (105° C.) | 1,320 |
| Total Dissolved Solids (180° C.) | 1,180 |
| Sodium | 345 |
| Calcium, as-ion | 2.0 |
| Magnesium, as-ion | 0.32 |
| Potassium | 13 |
| Silica by colorimetry | 133 |
| Silica by ICP | 222 |
| Total Sulfur | 13 |
| Sulfate | <10 |
| Chloride | 337 |
| Fluoride | 2.36 |
| p-Alkalinity (as CaCO₃) | 0 |
| t-Alkalinity (as CaCO₃) | 267 |
| Total Inorganic Carbon | 62.1 |
| Ammonia Nitrogen | 11.7 |
| Total Organic Carbon | 212³ |
| Oil & Grease | |
| Total Phosphorus | 0.29 |
| Aluminum | 0.16 |
| Arsenic | 0.06 |
| Barium | 0.069 |
| Boron | 8.24 |
| Cadmium | <0.01 |
| Chromium | <0.01 |
| Copper | <0.02 |
| Iron | 0.04 |
| Lead | <0.03 |
| Lithium | 0.47 |
| Manganese | 0.002 |
| Nickel | <0.01 |
| Selenium | <0.03 |
| Silver | <0.01 |
| Strontium | 0.15 |
| Zinc | 0.08 |

Results are given in mg/L on a filtrate basis, except for suspended solids.

In the evaporator, due to the increased cycles of concentration and the brine recirculation system, the dissolved salt content of the system water can be very high (i.e., 5-12%). This is much higher than that normally encountered in boiler operations. Typical cycles of concentration in these evaporators is from about 30×-40× wherein × indicates feedwater concentration. Due to the caustic fed to the system to raise pH and silica solubility, the majority of the calcium hardness precipitates in the sump as various forms of calcium silicate and, to a lesser extent, CaCO₃ (calcite). Chelants in the recirculating water system in these evaporators chelate the calcium and keeps it from scaling and/or plugging the evaporator tubes. It is to be kept in mind that calcium concentrations in these evaporators may range for example from about 7,500 to about 10,000 ppm. Such systems are prone to calcium silicate scale formation.

In one experimental field trial, EDTA was continuously fed to SAGD produced water used as feedwater to a vapor recompression falling film evaporator of the type shown in FIG. 2. This continuous EDTA feed was made at a stoichiometric excess with regard to the total chelatable species present in the water. Before the continuous EDTA feed, 85% of the calcium in the recirculating brine concentrate in the Evaporator precipitated and the majority of the calcium precipitant deposited in the evaporator. In contrast, after continuous EDTA feed, substantially all of the calcium stayed dissolved in the evaporator, (i.e., was transported all the way through the evaporator), indicating that scaling of the system surfaces, particularly the tube surfaces, was significantly inhibited. Additionally, the results indicated significant reduction in total suspended solids in the sump area after the continuous addition of the EDTA. Heat exchange values (the heat transfer coefficient or the U-value), measured along the condenser tubes remained constant after the continuous EDTA addition. In particular, the evaporator condenser pressure also remained steady, and there was no decline in distillate production at equivalent vapor compressor conditions during the duration of the test indicating again the lack of scale build up on the tube surfaces.

Prior to this field trial, the evaporator had been treated with a known antiscalant, namely 2-phosphonobutane, 1,2,4-tricarboxylic acid and a known dispersant. The conventional treatment was not successful in providing significant inhibition of scale accumulation in the evaporator.

Although the experimental data presently available has shown benefit of the treatment in evaporators, it is possible that the chelant treatment may also prove beneficial in crystallizers of the type normally used in zero liquid discharge and other systems.

While I have shown and described herein certain embodiments of the present invention, it is intended that there be covered as well any change or modification therein which may be made without departing from the spirit and scope of the invention as defined in the appended claims.

What is claimed is:

1. Method of inhibiting scale formation in an evaporator of the type having a brine recirculation system, said evaporator adapted to form distillate for feed to a boiler in a steam assisted gravity discharge oil recovery method, said method comprising:
a) providing feedwater for said evaporator from steam assisted gravity discharge produced water and
b) adding to said evaporator feedwater or to said brine recirculation system an effective amount of a chelant selected from the group consisting of ethylenediaminetriacetic acid (EDTA), diethylenetriaminepentaacetic acid (DTPA), nitrilotriacitic acid (NTA), and hydroxyethylethylenediaminetriacetic (HEEDTA) acid and water soluble salts thereof.

2. The method as recited in claim 1 wherein said chelant is present as a sodium salt.

3. The method as recited in claim 1 wherein said chelant is present in an amount of about 0.3 to about 3 times the stoichiometric amount of chelatable species in said brine recirculation system.

4. The method as recited in claim 1 wherein said evaporator is a falling film, vapor compression evaporation.

5. The method as recited in claim 1 wherein said chelant is EDTA.

6. Method of inhibiting scale formation in an evaporator used to evaporate water vapor in the form of distillate from a liquid medium comprising oil, water, scale causing ions, and silica, said method comprising adding to said liquid medium an effective amount of a chelant selected form the group consisting of EDTA, DTPA, NTA, and HEEDTA.

7. Method as recited in claim 6 wherein said silica is present in an amount of about 7,500-10,000 ppm and dissolved salt concentration of said liquid medium is about 5-12%.

8. Method as recited in claim 7 wherein the pH of said liquid medium is about 10-12.5.

9. Method as recited in claim 8 wherein said scale comprises calcium silicate and calcium carbonate scale.

10. Method as recited in claim 8 wherein SAGD produced water is fed to said evaporator.

11. Method as recited in claim 8 wherein said chelant is EDTA.

12. Method as recited in claim 11 wherein said evaporator is a falling film, vapor compression evaporator.

13. Method of evaporating aqueous distillate from a liquid medium in a system prone to calcium silicate deposition on structural parts in contact with said system, comprising adding to said liquid medium an effective amount to inhibit said calcium silicate deposition of a chelant selected from the group consisting of EDTA, DTPA, NTA, and HEEDTA.

14. Method as recited in claim 13 wherein said liquid medium has a pH of about 10-12.5, a silica content of about 7,500-10,000 ppm and a calcium ion content of greater than about 60 ppm.

15. Method as recited in claim 14 wherein said liquid further comprises oil.
